(19) United States
(12) Patent Application Publication
(10) Pub. No.: US 2012/0274759 A1
(43) Pub. Date: Nov. 1, 2012

(54) METHOD AND ARRANGEMENT FOR MONITORING CURRENT COLLECTORS AND HORIZONTAL AND VERTICAL CONTACT WIRE POSITION ON VEHICLE COMBINATIONS

(75) Inventors: Joachim Kaiser, Erlangen (DE); Nils-Michael Theune, Oberasbach (DE)

(73) Assignee: SIEMENS AKTIENGESELLSCHAFT, MUENCHEN (DE)

(21) Appl. No.: 13/498,644

(22) PCT Filed: Aug. 13, 2010
(86) PCT No.: PCT/EP2010/061814

§ 371 Date: Mar. 28, 2012

(30) Foreign Application Priority Data
Sep. 28, 2009 (DE) 10 2009 043 215.9

(51) Int. Cl. H04N 7/18

(52) U.S. Cl. 348/125; 348/E07.085

(57) ABSTRACT

A method and a device for monitoring a train set include at least one lateral camera and at least two upper cameras. The cameras are fixedly disposed on a track section laterally and above the train set. A region of the contact wire having a carrier device and at least one current collector can be detected by the at least one lateral camera and flanks of the train set can be detected by the at least two upper cameras. An evaluation unit is provided for determining the state of the at least one current collector, at least one clearance dimension of the train set and at least one actual position of the contact wire, or a combination thereof. Detected deviations from standards are indicated and allocated to individual cars.

The invention relates to the monitoring of vehicle combinations, in particular on electrified railroad train sets, wherein the maintaining of prescribed contact wire positions and the standard-compliant configuration of current collectors is checked.

According to current forecasts freight traffic will increase sharply in the coming years. For this reason, intelligent solutions are required for the administration and management of the goods flows concerned. Rail-borne freight traffic is currently characterized by competition with road transport. In order to be able to compete successfully, factors such as economy of operation, efficiency and reliability are of critical importance.

The method for checking the announcement data sets of a vehicle combination described in the German patent specification DE 19508730 C1 should, for example, be mentioned in connection with the organizing of a flexible composition of vehicle combinations (corresponds to the European Patent Application EP 0877695 B1). This deals in particular with rules for the correct disassembly and reformation of a combination. An important factor is the certain identification of individual cars of a vehicle combination, so that assignment to a pre-reported list, which reproduces the vehicle combination, can be checked. This system, which results in a decisive improvement in the control and monitoring of operational processes, ensures the certain recording and monitoring of the cars making up a vehicle combination.

In terminals, train marshalling yards and the loading and unloading points of seaports and works railheads, it is important for the efficient handling of the processes, that the precise order of the freight cars of incoming and outgoing freight trains is known. In large ports and works sites it may additionally be necessary to identify the freight cars at particular locations such as loading points, site boundaries etc. This requirement derives from different application instances such as:
Monitoring the composition of incoming trains arriving at train marshalling yards,
Recording the cars and their composition at handover and acceptance points for the controlling of operational workflows,
Basic data capture for billing purposes,
Input for the control of automatic loading and unloading processes,
Documentation for safety/security purposes and other tasks.

The principle of the subject matter according to patent specification DE 19508730 C1 consists in the fact that the recording of the freight and passenger cars and their composition in the train set can be employed while traveling past a reader station performing the method. Here an image is recorded with the aid of a high-speed 2048-pixel line scan camera as the train set travels past. This process is triggered by one or more wheel sensors. A lighting unit, in particular with light emitting diodes/LED is present adjacent to the track section for the purposes of illumination.

The recorded data relating to a train is compared with the target car composition from an announcement. Via the sensors of the system, characteristics of the freight cars are captured, which permit conclusions to be drawn about their identity. Typical characteristics are the axle pattern, axle weight and car number. Depending on the characteristic and combination of characteristics it is possible to determine the newness of the detection, as far as uniqueness. In train marshalling yards the actual car composition is compared with the target car composition announced in advance, and the consistency of the data checked.

The method according to DE 19508730 C1 describes a video-optical system, which performs one task only. This is the reading-off of individual car numbers on each individual car or the locomotive, and their analysis. The results can be forwarded to a post-processing software system, wherein subsequently a special form of “Optical Character Recognition/OCR” is in principle present. No further results are provided by the method cited.

According to the current prior art the contact wire stroke is for example determined with the aid of a string potentiometer, in which on one side a cable is attached to the contact wire at various points via a return pulley and at the other end of the cable the uplift or fall movement is recorded via a change in resistance on a string potentiometer. The disadvantage of this type of uplift measurement is the need to attach the cable with the aid of a contact wire clamp with a high voltage potential of typically 15 kV. For installation of the system the corresponding section of track must be disengaged both in terms of voltage and of the passage of traffic. This means significant costs and operational downtime. Furthermore, construction-related measuring errors occur as a result of hysteresis, in the case of precipitation such as snow or ice, and general temperature changes. Furthermore there have in past years been various incidents in which the cable has come adrift and caused damage to passing trains. As well as the established contact wire uplift measurement using a cable, developments involving a so-called video portal are beginning to emerge within private rail systems. Here, standard sensor technology is employed, in particular triangulation sensor systems, which record a red laser line projected onto the object of the measurement, such as a locomotive or freight car, with the aid of an angled, laterally arranged video camera. The result of the measurement is a three-dimensional overall image of the train set. This is compared with the permissible tolerance ranges for the stretch of rail track for, for example, the clearance profile of the locomotive and the utility cars, and a stop-go decision derived from this. The system cited has been in the experimental operational phase for a considerable time.

A further system should be mentioned in relation to the prior art, which is based on capacitive distance measurement. Here, an elastic sensor arm is suspended from a cross-beam above the contact wire onto the latter, and permanently connected thereto. The changes in the contact wire height are registered as a change in capacitance at the condenser of the sensor arm. Such a system is for example being employed by a Norwegian company. The energy supply at high voltage level is here handled optionally by means of a battery/rechargeable battery or in combination with a solar panel. The data transfer from high voltage to zero potential takes place optically using optical fibers.

The object of the invention is to describe a method and a device, with which important characteristics of train combinations and contact wires in the area of the catenary can be monitored, and faults recorded and quantified. A device in the nature of a measuring station on the track section of a train set is further to be described.

The object is achieved by the respective combination of the main claims. Advantageous embodiments can be taken from the subsidiary claims.

The invention is based on the knowledge that for monitoring of train combinations for the checking of at least the quality of current collectors or the actual position of the contact wire at a location on the track section, fixed cameras can be employed, which record characteristics of the train set or of the elements to be monitored and feed this into an evaluation unit, so that at least one target/actual comparison can be performed for fault detection. Here at least one lateral camera is provided, which captures the area of the catenary of a passing train and especially roof structures, linkage of current collectors, and the height of the contact wire relative to a target height.

By means of at least two upper cameras arranged over the track section of the train set and in each case aligned from above onto a flank of the train set, the maintaining of a maximum clearance dimension is advantageously monitored.

To measure an uplift height of the contact wire the vertical position of the contact wire is measured directly at the location of the camera and a measurement for the vertical contact pressure of the current collector on the contact wire of a passing train set is thus determined. At least one lateral camera is used for this purpose.

To measure the lateral deflection of the contact wire, the horizontal position of the contact wire is in turn directly measured at the location of the camera and thus a measurement determined, with which the horizontal deflection forces at a point on the catenary can be obtained. This is effected by at least one upper camera.

To measure the clearance profile of a train set the lateral dimensions of the flanks of the train set and the extent to which they exceed or undershoot the prescribed limits can be advantageously measured. To this end, the flanks of the train set are monitored parallel to their surface in each case by at least one upper camera.

Measurement of the state of the contact strip, the current collector bow, the current collector linkage and the roof structures is likewise performed directly at the location of a lateral camera, and compared with target values.

The cameras employed can be two-dimensional cameras with a camera chip embodied in planar form. Particularly advantageous, however, are one-dimensionally resolving line scan cameras, as for the representation of a two-dimensional image, the one-dimensional resolution of the camera is combined with the successive recording in the case of the passing train set. In order to make optimum use of this advantage, the orientation of the line scan cameras is to be performed in such a way that it positions its field of vision or the resolution capacity of the camera transversely to the track section of the train set or its direction of movement.

The inventive monitoring system can identify faults and allocate these to a particular area of the train set. It is particularly advantageous to determine the location of the fault on the train set. A car identification system can be used. This can be configured and constructed as desired, wherein it is advantageous if for example codes applied to the car can at the same time be resolved with the cameras of the measuring system.

Additional cameras are employed to improve measuring. For the at least one lateral camera, for example, at least one further camera is employed, if it is not possible, with a single camera, simultaneously to capture the area of the catenary or as the case may be the contact wire, for determining the contact wire height, and at the same time a code applied to a car. In the case of two lateral cameras attached one above the other at a specific distance, the capture of one characteristic in each case would be realizable without problems.

In order reliably to record both, that is the left-hand and right-hand flanks of a train set, the at least two upper cameras must be aligned in such a way that they observe the train flank in parallel from above. As the cameras can resolve parallel to the direction of travel, objects protruding outwards can be detected.

To represent, as far as possible, the entire train set, at the same time as possible faults occurring and the corresponding fault location, a strip image is advantageously created, which can be generated at a corresponding measuring point during the complete passage of a train set.

There follow descriptions of exemplary embodiments on the basis of schematic figures accompanying the invention but not limiting the same.

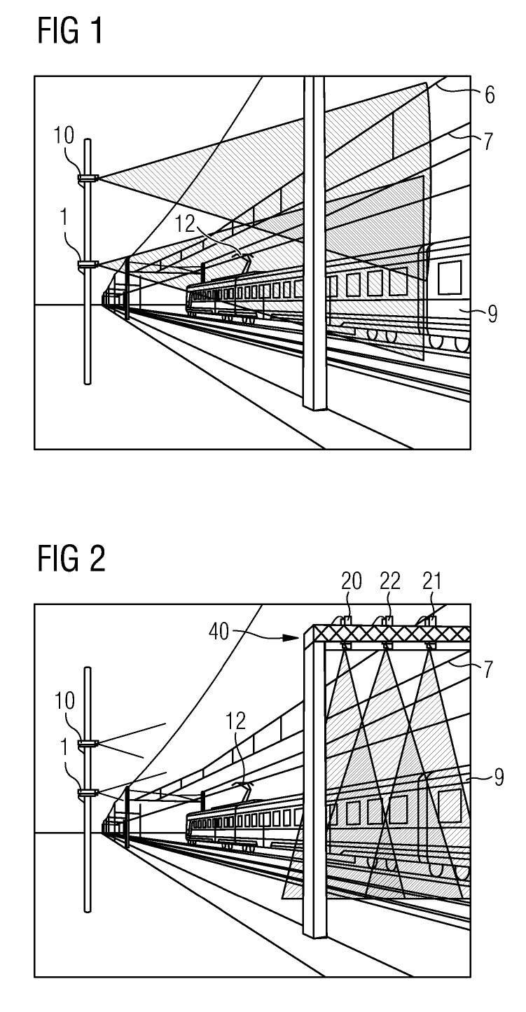

FIG. 1 shows a train set 9, on which are arranged a current collector 9 and a contact wire 7 and a carrying cable 6 and two lateral line scan cameras 10, 1;

FIG. 2 shows, in addition to the image characteristics according to FIG. 1, the lighting unit 40, which illuminates the fields of vision of upper cameras 20, 21, 22 and the point of intersection 11 between contact wire 7 and the field of vision of the upper supplementary camera 22;

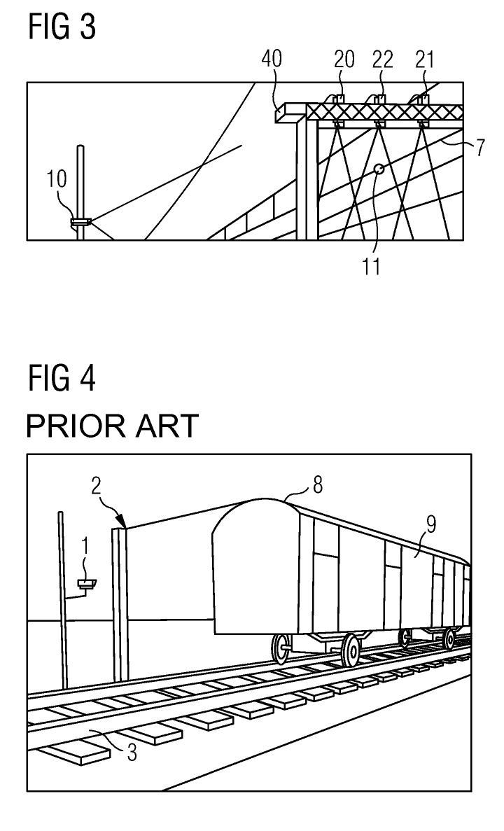

FIG. 3 shows an enlarged representation of the upper area according to FIG. 2;

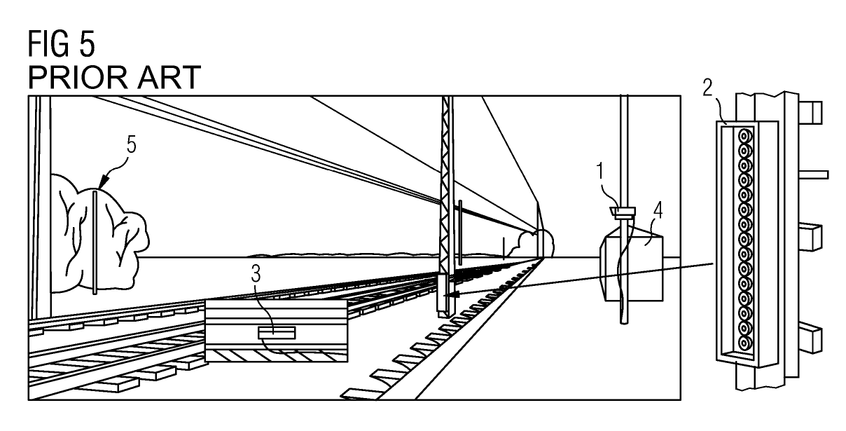

FIG. 4 shows a representation according to the prior art, wherein a car 8 is depicted, along with the lighting unit 2 with a planar beam, which illuminates the freight car 8 from the side, wherein the lateral camera 1 arranged on the track section serves solely to read codes applied to the car 8, and a wheel sensor for triggering corresponding recordings;

FIG. 5 shows a representation according to the prior art, in which for the reading of codes on a train set with a lateral camera 1, a line scan camera is positioned, along with a lighting unit 2, a wheel switch 3 and an evaluation unit 4 and a screen 5 for the camera.

A car identification system such as is described, for example, in the European patent specification EP 0 877 695 B1 can be used for example for coordination of faults recorded on a train set with the determining of the fault location.

A defined line of delimitation is designated the clearance profile, which is generally intended for the transverse vertical plane of a route, for example of roads or rail tracks. The clearance profile on the one hand prescribes the clear space on the track which is to be kept free of objects and obstacles, and on the other hand it also serves as a constructive standard for the measurement of the vehicles provided. These may not exceed the prescribed lines of delimitation in their cross section.

With reference to measurement of the height of the contact wire it should generally be noted that this contact wire position is the subject of acceptance checks on catenary systems. European standards are used for the permissible tolerances of the statistical rest position of the contact wire of standard catenaries.

To measure the contact wire height, the vertical position of the contact wire at the location of the line scan camera is identified and thus a measurement for the vertical contact pressure or contact force of the electric pantograph/current collector of a passing train set determined.

The measurement of the lateral deflection of the contact wire is significant, as the permissible standards-based values derive from different directives or result from manufacturer's specifications. A strong lateral contact wire deflection can furthermore be an indicator of an incorrectly adjusted or defective current collector or a defective contact strip. In serious cases, the train must here be prohibited from further travel, in order to avoid destruction of the catenary.

For measurement of the clearance profile of the train set, the lateral dimensions, that is the flanks of the train, are observed and their exceeding or undershooting of the statutory or manufacture-supplied data taken as the basis. Measurement of the state of the contact strips, the pantograph bow, the pantograph linkage and the roof structures likewise takes place directly at the location of a camera, in particular line scan camera, although upon the train passing the location the total number of pantographs and contact strips is recorded and analyzed.

The standards-based tolerance ranges permissible for the maximum and minimum allowable contact wire uplifts for a particular overhead contact line derive from a standard specification, European Standard EN 50119. The so-called stationary force, the sum of the static contact pressure and aerodynamic force with which the current collector, including bow and contact strips, presses against the contact wire, is described here. The measurement of the contact wire uplift thus gives a measurement for the undershooting or exceeding of the prescribed contact force, which represents the vertical and thus dominant portion of the quasi-stationary force.

The element of a catenary most subject to wear is the contact wire, the time in situ of which has a significant lifecycle costs. Changing of the contact wire under operational conditions is associated with high costs. Accordingly the wear to which the contact wire is subject is of great significance as regards lifecycle costs. FIG. 1 in particular is to be for measurement of the uplift height of the contact wire.

FIG. 1 shows an arrangement for measurement of the contact wire height in a vertical direction by means of a line scan camera, which is arranged laterally adjacent to the track section of a train set and is aligned with the area of the catenary. A change in the height of the contact wire is recorded by means of an image analysis, which can be the element of an evaluation unit 4. Under certain circumstances the image analysis can here be simplified by means of an additional measure, in that for example the area of the catenary captured by the camera is specially marked using aids such as miniature reflectors, reflective or suitable colored stripes. The seasonally-dependent expansion of the catenary must further be taken into account, and a correspondingly long catenary section marked. The described method is thereby particularly advantageous in that as a result of the additional provision of a car identification system with corresponding data, a unique identification of the respective locomotives, current collector or individual freight cars is enabled. This means considerably reduced effort for subsequent maintenance activities.

It should be pointed out with reference to FIG. 2 that a lateral deflection of the contact wire can be measured with an additional upper line scan camera, the upper camera 22. This is arranged above the contact wire, aligned vertically downwards, in order to record the lateral position of the contact wire. The irregular position of the contact wire is detected by comparison with target values, wherein in the case of a passing train set, successive recordings are actuated. It is also the case here that the identification of particular cars or particular sequences of cars means that the location of a fault within the train set can easily be determined by means of a car-identification system. This means considerably reduced effort for subsequent maintenance activities.

FIG. 3 shows an enlarged section of the image according to FIG. 2. As described, the contact wire identified with reference character 7 intersects the projection of line scan camera 22 at point 11. Upon the passage of a train, the contact wire will as a result of the contact wire uplift oscillate up and down and move a few centimeters to the left and the right. Through the image capture according to the invention and the use of line scan cameras in combination with one or more lighting units 4, 40 the representation can be illustrated according to FIGS. 2 and 3.

The line scan camera 20 and the line scan camera 21 with their optical axes, which in each case run vertically downwards, represent through their distance relative to each other, the maximum permissible clearance/overall width that the train set may have. Any exceeding of the dimensions on the right-hand and left-hand side of the car can be read out as image information from the respective data sets. The train set is thus monitored with regard to its lateral dimensions, and projecting and displaced parts of the load, such as for example antennae, tarps etc., can be detected if they extend beyond the train flank 13. This method is particularly advantageous, as through the combination with the car-identification system, an identification of the car or locomotive causing the problem or the current collector is enabled.

As is evident in FIG. 1 measurement of a contact wire stroke can be performed by the line scan camera 10. In addition train-mounted structures and also further parts of the catenary can be detected. Furthermore, exceeding of the permissible height of the clearance dimension can be determined. This is in particular measured by the camera 10 according to its orientation in such away that it is established where the roof height of a car or a locomotive exceeds the maximum permissible height. In the recorded image of the train set an upward exceeding of the clearance dimension can be detected as a fault. An exception to this is or are of course the current collector/collectors, which, depending on the system, are pressed against the contact wire as stirrups above the roof construction.

According to the representation in FIG. 1 it is advantageous that not only the lateral section of the entire catenary, that is to say the contact wire and the carrying cable, are recorded, but also any roof structures on passing trains. The current collector with its complete linkage and the other structures mounted on the train should in particular be mentioned in this connection. This video-optical or photographic recording for example of a current collector has the particular advantage that the geometry of the current collector can be compared with target standards, and deviations, which can be attributed only to damage to the current collector can be determined at an early stage. The triggering of a signal, followed by an action plan, could thus halt the train with a damaged current collector or provide for its inspection in a siding.

The monitoring of a train set can be performed on the basis of various characteristics. Overall, certain dimensions or geometric embodiments can be compared to target values, which are stored in databases, and a fault can be detected in a timely manner.

1-13. (canceled)

14. A method for monitoring a train set by checking at least one current collector or at least one actual position of a contact wire or a combination thereof, the method comprising the following steps:
providing at least one fixed, lateral camera set up adjacent a track section of the train set and aligned with the train set;
recording a vertical position of the contact wire at a location of the at least one fixed, lateral camera and at least one upper limit of the train set, with the at least one fixed, lateral camera;
providing at least two fixed upper cameras disposed over the track section of the train set and aligned vertically from above at the same location on the track section as the at least one fixed, lateral camera;
recording a horizontal position of the contact wire, with the at least two fixed upper cameras;
providing an evaluation unit; and
determining a state of the at least one current collector or the at least one actual position of the contact wire or a combination thereof, with the evaluation unit; and
indicating faults.

15. The method according to claim 14, which further comprises additionally monitoring at least one clearance dimension by:
recording horizontal positions of flanks of the train set and the contact wire with the at least two fixed upper cameras each being aligned vertically from above with a respective one of the flanks, at the same location on the track section as the at least one fixed, lateral camera; and
additionally determining, with the evaluation unit, the at least one clearance dimension or a combination of the at least one clearance dimension, the state of the at least one current collector and the at least one actual position of the contact wire; and
indicating faults.

16. The device according to claim 14, which further comprises indicating deviations from prescribed standards as the faults.

17. The method according to claim 14, wherein the at least one fixed, lateral camera and the at least two upper cameras are line scan cameras each having a line oriented transversely to the track section of the train set.

18. The method according to claim 14, which further comprises implementing a car identification system by capturing codes on the cars with at least one of the at least one fixed, lateral camera and identifying the codes with the evaluation unit, for allocating occurring faults to a corresponding car.

19. The method according to claim 14, which further comprises providing at least one further lateral camera for reading codes on the train set to allocate detected faults to a particular car.

20. The method according to claim 14, which further comprises providing a further upper camera, in addition to the at least two fixed upper cameras, for separate recording of the horizontal position of the contact wire.

21. The method according to claim 14, which further comprises creating at least one strip-like image of the train set with the fixed cameras and indicating the detected faults on the strip-like image.

22. The method according to claim 14, which further comprises monitoring the current collectors by measuring contact strips of the current collectors and measuring a linkage of the current collectors and various roof structures mounted on the train set.

23. A device for monitoring a train set, the device comprising:
at least one lateral camera;
at least two upper cameras;
said cameras being fixed to a track section laterally and above the train set;
said at least one lateral camera configured to capture a region of a contact wire with a carrier device and at least one current collector; and
an evaluation unit configured for determining a state of the at least one current collector and at least one actual position of the contact wire or a combination thereof.

24. The device according to claim 23, wherein said at least two upper cameras are configured to additionally capture flanks of the train set.

25. The device according to claim 23, wherein said evaluation unit is additionally configured to determine at least one clearance dimension of the train set.

26. The device according to claim 23, which further comprises a lighting unit provided for said at least one lateral camera and a lighting unit provided for said at least two upper cameras, to illuminate fields of vision respectively associated with each of said cameras.
